(19) United States
(12) Patent Application Publication
(10) Pub. No.: US 2024/0255957 A1
(43) Pub. Date: Aug. 1, 2024

(54) Method and Device for Storing a Shortened Section of a Travel Trajectory

(71) Applicant: Bayerische Motoren Werke Aktiengesellschaft, Muenchen (DE)

(72) Inventors: Mohamad Mounir EL DANA, Muenchen (DE); Benedikt HOFFMANN, Muenchen (DE); Benjamin KRIMMER, Muenchen (DE); Rebecca PASCAL, Muenchen (DE); Daniel TELSCHOW, Muenchen (DE)

(21) Appl. No.: 18/427,106

(22) Filed: Jan. 30, 2024

(30) Foreign Application Priority Data
Jan. 31, 2023 (DE) 10 2023 102 217.2

(51) Int. Cl. G05D 1/646; G05D 1/223; G05D 1/224

(52) U.S. Cl. CPC G05D 1/646; G05D 1/223; G05D 1/2247

(57) ABSTRACT

An apparatus includes a device. The device is configured to store a travel trajectory of a driving maneuver of a vehicle associated with repeated performance of the driving maneuver. The device is configured to cause a travel trajectory of the vehicle to be recorded while the vehicle is traveling. The device is also configured to determine a shortened section of the recorded travel trajectory. The device is configured to store the shortened section of the recorded travel trajectory in a memory unit associated with the repeated performance of the driving maneuver.

### BACKGROUND AND SUMMARY

This application claims priority under 35 U.S.C. § 119 from German Patent Application No. 10 2023 102 217.2, filed Jan. 31, 2023, the entire disclosure of which is herein expressly incorporated by reference.

The disclosure relates to a method and a corresponding device which are configured to assist the user of a vehicle during repeated performance of driving maneuvers.

A vehicle may have a driver assistance function which enables the user of the vehicle to record and store a travel trajectory driven in manual driving mode. The stored travel trajectory may be used at a later point in time to automatically control the vehicle along the stored travel trajectory. In this way, the comfort of the vehicle may be increased with regard to the repeated performance of driving maneuvers.

The recording of a travel trajectory may, if necessary, be started explicitly by the user. Alternatively, a travel trajectory may be automatically recorded (e.g. using a circular buffer) without the recording having to be started explicitly. The recorded travel trajectory may then be stored in a memory unit of the vehicle for repeated performance of the driving maneuver.

The present disclosure relates to the technical problem of increasing the convenience of a vehicle user when recording and subsequently storing a travel trajectory.

The problem is solved by each of the independent claims. Advantageous embodiments are described, inter alia, in the dependent claims. It should be noted that additional features of a claim dependent on an independent patent claim without the features of the independent patent claim or only in combination with a subset of the features of the independent patent claim may form a separate disclosure independent of the combination of all features of the independent patent claim, which may be made the subject of an independent claim, a divisional application or a subsequent application. This applies in the same way to technical teachings described in the description, which may form a disclosure independent of the features of the independent claims.

According to one aspect, a device for recording and/or storing a travel trajectory of a (motor) vehicle is described. The device is configured to record the travel trajectory of the vehicle (in particular automatically) while the vehicle is moving. While driving, longitudinal and/or lateral control of the vehicle may be manually performed by the driver. The travel trajectory of the vehicle may be stored in a volatile memory, in particular in a circular buffer of the vehicle (with the circular buffer being cyclically overwritten while driving if the travel trajectory is longer than the maximum storable travel distance of the circular buffer). The travel trajectory of the vehicle may be recorded without (explicit and/or dedicated) recording of the travel trajectory of the journey having been requested by the user, in particular by the driver, of the vehicle via the user interface of the vehicle.

As part of recording the travel trajectory, trajectory data may be acquired and recorded. The trajectory data may specify for each of a plurality of points and/or positions along the travel trajectory (starting at a start position to an end position of the trajectory)
the coordinates of the respective position;
the orientation and/or heading of the vehicle at the respective position; and/or
the speed of the vehicle at the respective position.

The trajectory data of the travel trajectory may be stored (at the request of the vehicle user) in a memory unit of the vehicle. Furthermore, the trajectory data may be used in a replay mode to automatically drive the vehicle (with automated longitudinal and/or lateral control) along the travel trajectory (from the start position to the end position of the travel trajectory).

The device may therefore be configured to record a travel trajectory of the vehicle while the vehicle is traveling. During the journey, trajectory data of the travel trajectory may be stored in a volatile memory, in particular in a circular buffer, of the vehicle. The recorded travel trajectory may extend from a recorded start position to a recorded end position. In particular, the recorded travel trajectory may start at the recorded start position and end at the recorded end position.

As already explained, the travel trajectory may be recorded automatically, in particular without explicit request from the user of the vehicle. The device may be configured to detect that while the vehicle is moving, the travel speed of the vehicle is equal to or less than a predefined speed threshold value. In response thereto, the travel trajectory of the vehicle may be recorded automatically.

The device is further configured to determine (in particular based on a user input from the user) a shortened section of the recorded travel trajectory. The shortened section of the recorded travel trajectory may have an adapted start position downstream of the recorded start position and/or an adapted end position upstream of the recorded end position.

In particular, it may be possible for the user of the vehicle to shorten the recorded travel trajectory following recording (and before final storage in the vehicle storage unit). In particular, the start position (along the recorded travel trajectory) may be shifted backward and/or the end position (along the recorded travel trajectory) may be shifted forward.

The device may further be configured (in particular in response to user input) to store the shortened section of the recorded travel trajectory in the memory unit (of the vehicle) for repeated performance of the driving maneuver. In the replay mode, the vehicle may be driven with lateral and/or longitudinal control along the shortened section of the travel trajectory from the adapted start position and not already from the recorded start position and/or only to the adapted end position and not to the recorded end position.

A device is therefore described which enables the user of the vehicle to adapt the start and/or end position of a(n) (automatically) recorded travel trajectory to their personal requirements and to store it in an adapted form. In this way, a particularly convenient recording of a travel trajectory may be achieved for the repeated performance of a driving maneuver.

The device may be configured to (only) store the trajectory data of the shortened section of the recorded travel trajectory in the memory unit of the vehicle. The storage unit may be provided and/or configured to permanently store trajectory data.

On the other hand, the device may be configured to delete the trajectory data of one or more further sub-sections, in particular of all sub-sections of the recorded travel trajectory, which are outside of the shortened sub-section of the recorded travel trajectory, from the volatile memory and/or not to store them in the storage unit. The trajectory data of the one or more partial sections of the recorded travel trajectory that are not considered may therefore be (irrevocably) discarded. This enables particularly resource-efficient recording and storage of a travel trajectory.

Following the journey of the vehicle, the device may be configured to graphically display (for example on a screen of the user interface) the recorded travel trajectory, which extends from the recorded start position to the recorded end position to the user of the vehicle via a user interface (of the vehicle and/or a mobile user device).

The device may further be configured to capture, via the user interface, a user input with regard to the start position adapted with regard to the recorded start position and/or with regard to the end position adapted with regard to the recorded end position. The user interface may be configured so that the recorded start position may be moved by the user along the recorded travel trajectory in order to cause the user input in relation to the adapted start position, and/or so that the recorded end position may be moved by the user along the recorded travel trajectory in order to cause the user input with regard to the adapted end position.

The shortened section of the recorded travel trajectory may then be determined based on the adapted start position and/or based on the adapted end position. In particular, a shortened subsection may be determined which
starts at the adapted start position and ends at the recorded end position; or
starts at the adapted start position and ends at the adapted end position; or
starts at the recorded start position and ends at the adapted end position.

It is therefore possible for the user to adapt the recorded travel trajectory in a particularly convenient manner by means of a graphical user interface.

The device may be configured to capture a sequence of camera images for a corresponding sequence of points or positions on the recorded travel trajectory while driving using at least one environmental camera of the vehicle and to store them in a, in particular volatile, memory. The camera images may each display the (front-side) environment of the recorded travel trajectory at the respective point on the travel trajectory.

The sequence of camera images may be provided for the determination of the shortened section of the recorded travel trajectory by the user of the vehicle. In particular, the device may be configured to enable the user via the user interface to select a point on the recorded travel trajectory as an adapted start position or as an adapted end position of the partial section of the recorded travel trajectory (for example by shifting along the recorded travel trajectory). The camera image for the point selected by the user on the recorded travel trajectory may then be displayed via the user interface.

The display of camera images for different points along the recorded travel trajectory enables defining the shortened section of the recorded travel trajectory in a particularly convenient manner. The camera images may be deleted and/or discarded following the definition and/or storage of the shortened section in order to enable resource-efficient recording of a travel trajectory.

According to a further aspect, a (road) motor vehicle (in particular a passenger car or a truck or a bus or a motorcycle) is described, which comprises the device described in this document.

According to a further aspect, a method is described for determining and/or storing a travel trajectory of a vehicle maneuver for repeated performance of the driving maneuver. The method comprises causing a travel trajectory of the vehicle to be recorded while the vehicle is moving. The method further comprises determining a shortened section of the recorded travel trajectory, and storing the shortened section of the recorded travel trajectory in a storage unit (of the vehicle) for repeated performance of the driving maneuver.

According to a further aspect, a software (SW) program is described. The SW program may be configured to be executed on a processor (for example on a vehicle control device) and thus to perform the method described in this document.

According to a further aspect, a storage medium is described. The storage medium may include an SW program which is configured to be executed on a processor and thus to carry out the method described in this document.

It should be noted that the methods, devices and systems described in this document may be used alone or in combination with other methods, devices and systems described in this document. Furthermore, any aspect of the methods, devices and systems described in this document may be combined in a variety of ways. In particular, the features of the claims may be combined with one another in a variety of ways. Furthermore, features listed in parentheses are to be understood as optional features.

The disclosure is described in more detail below based on exemplary embodiments. In this context,

Other objects, advantages and novel features of the present disclosure will become apparent from the following detailed description of one or more preferred embodiments when considered in conjunction with the accompanying drawings, in which:

### BRIEF DESCRIPTION OF THE DRAWINGS

FIG. 1 shows exemplary components of a vehicle;

FIG. 2a shows an example of an automatically recorded travel trajectory;

FIG. 2b shows an exemplary graphical user interface for selecting a shortened section of the recorded travel trajectory; and

FIG. 3 shows a flow chart of an exemplary method for storing a section of a vehicle's travel trajectory.

### DETAILED DESCRIPTION OF THE DRAWINGS

As explained above, the present document relates to increasing the comfort of a user of a vehicle when recording and/or defining a travel trajectory for repeated performance of a driving maneuver. In this context, FIG. 1 shows an exemplary vehicle 100 with one or more environmental sensors 102 (e.g. at least one camera, at least one radar sensor, at least one lidar sensor, at least one ultrasonic sensor, etc.), which are each configured to detect environmental data (i.e. sensor data) relating to the environment of the vehicle 100. A control device 101 of the vehicle 100 may be configured to evaluate the environmental data in order to detect one or more objects in the vicinity of the vehicle 100.

The device 101 may also be configured to operate one or more longitudinal and/or transverse control actuators 103 of the vehicle 100 (for example a drive motor, a brake device and/or a steering device) in order to automatically perform longitudinal and/or lateral control of the vehicle 100. The one or more actuators 103 may be operated as a function of the environmental data, in particular as a function of the one or more detected objects.

The vehicle 100 may also include a user interface 104, which enables interaction between the user and the vehicle 100, for example to activate or deactivate a driver assistance system and/or to inform the user about the status of a driver assistance system. The user interface 104 may include one or more operating elements and/or one or more output elements (for example a screen).

The vehicle 100 may include a driver assistance system which is configured to record a travel trajectory driven by the vehicle 100. The travel trajectory may be driven manually by the driver of the vehicle 100 and/or automatically by the vehicle 100. Trajectory data relating to the travel trajectory may be stored in a memory unit 105 of the vehicle 100. The trajectory data may display for each of a plurality of positions along the travel trajectory,
coordinates of the respective position (for example relative to a world coordinate system and/or relative to a coordinate system of the vehicle 100);
an orientation and/or heading of the vehicle 100 at the respective position;
a travel speed of the vehicle 100 at the respective position;
one or more surrounding objects in the vicinity of the vehicle 100; and/or
the distance of the vehicle 100 from the one or more environmental objects in the vicinity of the vehicle 100.

The recording of a travel trajectory may be started and/or stopped explicitly by the user of the vehicle 100 (via the user interface 104). Accordingly, the starting point and/or the end point of the stored travel trajectory may be defined precisely. On the other hand, it may occur that the user forgets to start recording the travel trajectory, so that the driving maneuver associated with the travel trajectory must be performed again in order to record the travel trajectory.

The device 101 may be configured to automatically record a travel trajectory (without the recording having to be started explicitly by the user). Automatic recording may be limited to a specific maximum travel distance that may be stored (for example between x=50 and 200 meters). For example, the device 101 may be configured to store the last x meters of a travel trajectory in a circular buffer of the vehicle 100, the first section of a stored travel trajectory being overwritten by the last section of the travel trajectory as soon as the maximum storable travel distance is exceeded.

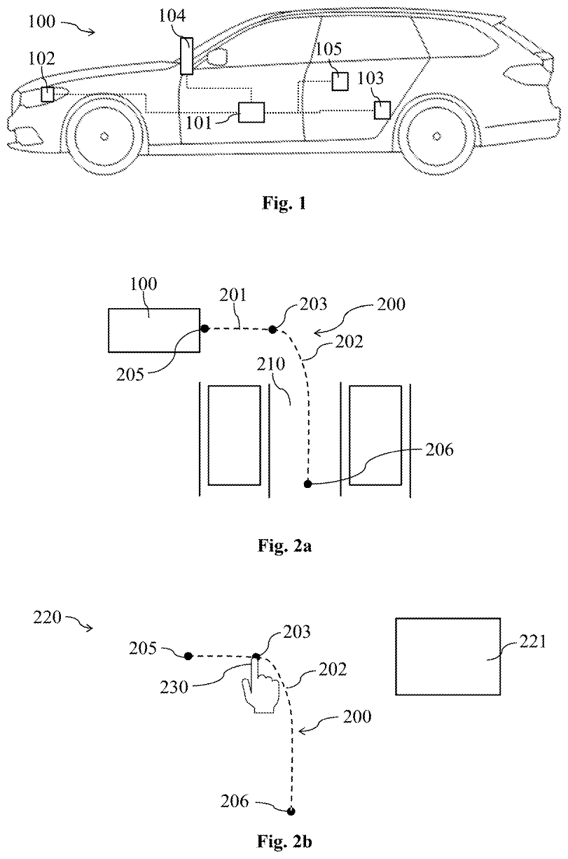

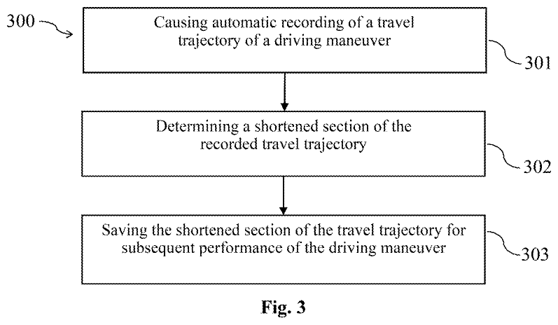

FIG. 2a shows an exemplary driving situation in which the vehicle 100 travels along a travel trajectory 200 to a parking space 210. In each case, the last driven part of the travel trajectory 200 may be automatically stored in the circular buffer, so that after the vehicle 100 has been parked at an end position 206 in the parking space 210, the last driven part of the travel trajectory 200 is stored in the circular buffer of the vehicle 100. The stored part of the travel trajectory 200 may correspond to the maximum travel distance that may be stored. In the example shown in FIG. 2a, the automatically recorded travel trajectory 200 extends from the recorded start position 205 to the recorded end position 206.

The automatically recorded travel trajectory 200 may (on the initiative of the user) be stored permanently in the memory unit 105 of the vehicle 100 and may be used for repeated performance of the driving maneuver associated with the travel trajectory 200. For example, the vehicle 100 may (in a replay mode of the driver assistance system) be driven automatically from the recorded start position 205 of the recorded travel trajectory 200 to the recorded end position 206 within the parking space 210 during repeated performance of the driving maneuver. Alternatively (in order to provide a reverse assistance function), an at least partially automated return journey (for example with automated lateral control and with automated or manual longitudinal control) may be performed along the travel trajectory 200 based on the stored trajectory data for the travel trajectory 200 (for example to drive the vehicle 100 out of parking space 210).

The automatic recording of the travel trajectory 200 may be caused or prevented as a function of one or more recording conditions. An exemplary recording condition is that the travel speed of vehicle 100 is equal to or less than a predefined (recording) speed threshold value. Automatic recording is automatically started (potentially only if it is detected that one or more recording conditions have been met).

The route of travel trajectory 200 recorded for a driving maneuver as part of the automatic recording may not correspond to the route desired by the user for repeated performance of the driving maneuver. In particular, the automatically recorded route may be longer than the desired route for repeated performance of the driving maneuver.

The user of the vehicle 100 may be enabled (for example via the user interface 104 of the vehicle 100) to select a shortened section 202 of the (optionally automatically) recorded travel trajectory 200. In particular, an adapted start position 203 may be selected, with the adapted start position 203 (subsequent to the originally recorded start position 205) being arranged on the recorded travel trajectory 200. Alternatively or additionally, the end position 206 may optionally be adapted, in particular brought forward along the recorded travel trajectory 200.

It is therefore possible to select a shortened subsection 202 of the recorded travel trajectory 200, wherein the subsection 202 comprises
an adapted start position 205 (on the recorded travel trajectory 200) shifted with respect to the original, recorded start position 205; and/or
an adapted end position (on the recorded travel trajectory 200) shifted with respect to the original, recorded end position 206.

The selected, shortened sub-section 202 of the recorded travel trajectory 200 may be stored permanently in the memory unit 105 of the vehicle 100 for subsequent performance of the driving maneuver. On the other hand, the one or more partial sections 201 of the recorded travel trajectory 200 that are not taken into account may be discarded and/or deleted (or overwritten in the circular buffer during a subsequent journey).

The user interface 104 of the vehicle 100 may include a screen on which the recorded travel trajectory 200 may be graphically displayed, for example using a bird's eye view. FIG. 2b shows an exemplary graphical illustration 220 of the travel trajectory 200. It may be possible for the user to set an adapted start position 203 and/or an adapted end position, for example by touching a point on the illustrated travel trajectory 200 with a finger 230. For example, the user may be enabled to move the finger 230 along the shown travel trajectory 200 and thus change the adapted start position 203 or the adapted end position.

While recording the travel trajectory 200, camera images 221 of the environment of the vehicle 100 may have been repeatedly captured and (at least temporarily) stored using the one or more environmental cameras 102 of the vehicle 100. For example, a camera image 221 may have been captured and stored at a distance of y cm (for example y between 10 and 50). The individual camera images 221 may each be associated with a position on the recorded travel trajectory 200. Furthermore, the individual camera images 221 may each display the environment, in particular the view of the environment of the driver of the vehicle 100, at the respective position.

The recorded camera images 221 may be made available to the user, in particular displayed, in order to assist the user in selecting a suitable, shortened section 202 of the travel trajectory 200. For example, a camera image 221 respectively associated with an adapted start or end position 203 selected by the user may be displayed on the graphical display 220. This enables a particularly convenient and precise selection of a shortened section 202 of the recorded travel trajectory 200.

As explained above, during automatic recording, the user of the vehicle 100 is typically not aware of where the recorded start position 205 of the automatically recorded travel trajectory 200 is located. The recorded start position 205 may depend, for example, on the maximum travel distance which may be stored in the circular buffer.

During the (automatic) recording of a travel trajectory 200, camera images 221 (in particular frames) of the front camera 102 of the vehicle 100 may be buffered and assigned to the path points along the recorded travel trajectory 200. The start position (SP) 205 and the parking end position (PEP) 206 may be placed on the path as variable points after recording the travel trajectory 200 has ended. In particular, it is possible for the user (via the user interface 104) to move the SP and/or the PEP along the recorded path 200 in order to define an adapted SP 203 and/or to define an adapted PEP. When moving a point (SP or PEP), the user may be shown the camera image 221 for the currently selected path position. After adapting the SP and/or PEP, the selected subsection 202 of the travel trajectory 200 may be stored in the storage unit 105. Once saved, path changes (in particular path extensions) are typically no longer possible. Furthermore, the camera images 221 may be deleted from the buffer memory.

In an example scenario, the user manually parks the vehicle 100 in a parking space 210 and initiates the “Save maneuver” action via the user interface 104. In response to this, a graphical representation 220 of the traveled path 200 may be displayed on a screen of the user interface 104. In this case, the start and/or end position 205, 206 may be highlighted (to indicate to the user that they may be shifted).

The user may then shift the start and/or end position within or along path 200 and then save it. In this case, the camera images 221 of the respective selected position may be displayed to the user.

It should be noted that the user interface 104 may be installed in the vehicle 100. Alternatively or additionally, the user interface 104 may be provided (at least in part) via a (mobile) user device (such as a smartphone). In particular, it may be possible for the user to adapt a recorded trajectory 200 via a user device and to store it permanently (in the memory unit 105 of the vehicle 100).

FIG. 3 shows a flow chart of a method 300 (possibly computer-implemented) for recording and/or storing a travel trajectory 200 of a driving maneuver of a vehicle 100 for repeated performance of the driving maneuver. The method 300 comprises causing 301 recording a travel trajectory 200 of the vehicle 100 during (manual) travel of the vehicle 100. The recording may take place automatically (for example in a circular buffer of the vehicle 100).

The method 300 further comprises determining 302 of a shortened section 202 of the recorded travel trajectory 200. The recorded travel trajectory 200 may have been shortened by a user of the vehicle 100 via a user interface 104 (in particular by adapting the start position 205, 203 and/or the end position 206). The shortened subsection 202 may extend
from the adapted start position 203 to the recorded end position 206; or
from the adapted start position 203 to the adapted end position; or
from the recorded start position 205 to the adapted end position.

The shortened subsection 202 may be delimited by the respective start or end position.

The method 300 further comprises storing 303 the shortened section 202 of the recorded travel trajectory 200 in the memory unit 105 (of the vehicle 100) for repeated performance of the driving maneuver. In particular, only the shortened subsection 202 of the recorded travel trajectory 200 (and not the one or more further subsections 201 of the recorded travel trajectory 200) may be stored in the memory unit 105 for the driving maneuver.

The measures described in this document may increase the convenience of recording and storing a travel trajectory 200 for repeated performance of a driving maneuver in an efficient and reliable manner.

The present disclosure is not limited to the exemplary embodiments shown. In particular, it should be noted that the description and the figures are only intended to illustrate the principle of the proposed methods, devices and systems by way of example.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

What is claimed is:

1. An apparatus comprising:
a device configured to store a travel trajectory of a driving maneuver of a vehicle associated with repeated performance of the driving maneuver, wherein the device is configured to:
cause a travel trajectory of the vehicle to be recorded while the vehicle is traveling;
determine a shortened section of the recorded travel trajectory; and
store the shortened section of the recorded travel trajectory in a memory unit associated with the repeated performance of the driving maneuver.

2. The apparatus according to claim 1, wherein
while driving, trajectory data for the travel trajectory are stored in a circular buffer, of the vehicle; and
the device is configured to:
store the trajectory data for the shortened subsection of the recorded travel trajectory in a storage unit of the vehicle associated with permanent storage of trajectory data; and
delete the trajectory data associated with one or more further sub-sections, in particular for all sub-sections of the recorded travel trajectory, which are located outside of the shortened sub-section of the recorded travel trajectory, from the volatile memory and/or not to store them in the storage unit for permanent storage of trajectory data.

3. The apparatus according to claim 1, wherein
the recorded travel trajectory extends from a recorded start position to a recorded end position; and
the device is configured to determine a shortened subsection of the recorded travel trajectory, the shortened subsection having:
an adapted start position shifted backward from the recorded start position on the recorded travel trajectory; and/or
an adapted end position on the recorded travel trajectory shifted forward from the recorded end position.

4. The apparatus according to claim 1, wherein the device is configured to determine the shortened section of the recorded travel trajectory based on a user input from a user of the vehicle.

5. The apparatus according to claim 1, wherein the device is configured to, following the journey of the vehicle:
cause the recorded travel trajectory extending from a recorded start position to a recorded end position to be graphically displayed to a user of the vehicle via a user interface;
capture, via the user interface, a user input with regard to a start position adapted with regard to the recorded start position and/or with regard to an end position adapted with regard to the recorded end position; and
to determine the shortened section of the recorded travel trajectory based on the adapted start position and/or based on the adapted end position.

6. The apparatus according to claim 5, wherein the user interface is configured so that:
the recorded start position is shifteable by the user along the recorded travel trajectory in order to cause the user input with regard to the adapted start position; and/or
the recorded end position is shifteable by the user along the recorded travel trajectory in order to cause the user input with regard to the adapted end position.

7. The apparatus according to claim 1, wherein the device is further configured to:
record a sequence of camera images for a corresponding sequence of points on the recorded travel trajectory using an environmental camera of the vehicle while driving to record the travel trajectory and to store them in a volatile, memory; and
providing the sequence of camera images for defining the shortened section of the recorded travel trajectory by a user of the vehicle.

8. The apparatus according to claim 7, wherein the device is further configured to:
allow the user, via a user interface, to select a point on the recorded travel trajectory as an adapted start position or as an adapted end position of the section of the recorded travel trajectory; and
display the camera image for the point selected by the user on the recorded travel trajectory via the user interface.

9. The apparatus according to claim 1, wherein
the shortened subsection of the recorded travel trajectory and stored in the memory unit includes an adapted start position shifted backward with regard to a recorded start position of the recorded travel trajectory and/or an adapted end position shifted forward with regard to a recorded end position of the recorded travel trajectory; and
the device is further configured, for a repeated performance of the driving maneuver in a replay mode, to cause the vehicle to only from the adapted start position, and not already from the recorded start position; and/or
only up to the adapted end position, and not up to the recorded end position be automatically driven based on longitudinal and/or lateral control along the shortened section of the travel trajectory.

10. The apparatus according to claim 1, wherein the device is further configured to:
automatically record the travel trajectory while the vehicle is moving without explicit request from a user of the vehicle; and/or
record the travel trajectory in a circular buffer of the vehicle while the vehicle is moving; and/or
to detect that, while the vehicle is moving, a travel speed of the vehicle is equal to or less than a speed threshold value; and
in response to the detection, automatically record the travel trajectory of the vehicle.

11. A method for storing a travel trajectory of a driving maneuver of a vehicle for repeated performance of the driving maneuver; the method comprising:
recording of a travel trajectory of the vehicle while the vehicle is moving;
determining a shortened section of the recorded travel; and
storing the shortened section of the recorded travel trajectory in a storage unit for repeated performance of the driving maneuver.
